(19) United States
(12) Patent Application Publication
(10) Pub. No.: US 2026/0026611 A1
(43) Pub. Date: Jan. 29, 2026

(54) CONTROL METHOD OF ELECTRIC TOOTHBRUSH, APPARATUS, ELECTRONIC DEVICE, AND STORAGE MEDIUM

(71) Applicant: NINGBO SEAGO ELECTRIC CO., LTD., Ningbo City (CN)

(72) Inventors: Huiming Liu, Ningbo City (CN); Yanzhong Cai, Ningbo City (CN); Kaikai Hu, Ningbo City (CN); Yuli Wang, Ningbo City (CN)

(21) Appl. No.: 19/023,231

(22) Filed: Jan. 15, 2025

(30) Foreign Application Priority Data
Jul. 29, 2024 (CN) 202411027731.5

(51) Int. Cl. A46B 15/00; A46B 13/02; A46B 17/08; A61C 17/22; G09B 19/00; H04L 51/046; H04L 51/58

(52) U.S. Cl. CPC A46B 15/0008; A46B 13/02; A46B 15/001; A46B 15/0012; A46B 15/0044; A46B 17/08; A61C 17/224; G09B 19/0084; H04L 51/046; H04L 51/58

(57) ABSTRACT

The present disclosure relates to a control method of an electric toothbrush, an apparatus, an electronic device, and a storage medium, including: determining real-time monitoring data during a brushing process of a target user based on the electric toothbrush, and transmitting the real-time monitoring data to a base corresponding to the electric toothbrush based on a wireless communication network, wherein the real-time monitoring data is used to reflect a movement condition of a brush head of the electric toothbrush, and the base is configured to place the electric toothbrush and to charge the electric toothbrush; and determining the reminding message displayed on the base according to the real-time monitoring data, wherein the reminding message is used to indicate a cleanliness degree corresponding to each dental region of the target user.

### CROSS-REFERENCE TO RELATED APPLICATION

The present disclosure claims priority to Chinese patent application No. 2024110277315, filed with the Chinese Patent Office on Jul. 29, 2024, the entire contents of which are incorporated herein by reference.

### TECHNICAL FIELD

The present disclosure relates to the technical field of electric toothbrushes, and in particular to a control method of an electric toothbrush, an apparatus, an electronic device, and a storage medium.

### BACKGROUND ART

The electric toothbrush is a commonly used oral health care product today. The electric toothbrush in the prior art usually lacks monitoring for the brushing process of the user, which cannot determine whether different dental regions are cleaned in place during the brushing process of the user, and cannot help the user develop a good brushing habit.

### SUMMARY

In view of this, the present disclosure provides technical solutions of a control method of an electric toothbrush, an apparatus, an electronic device, and a storage medium.

One aspect of the present disclosure provides a control method of the electric toothbrush, including: determining real-time monitoring data during a brushing process of a target user based on the electric toothbrush, and transmitting the real-time monitoring data to a base corresponding to the electric toothbrush based on a wireless communication network, wherein the real-time monitoring data is used to reflect a movement condition of a brush head of the electric toothbrush, and the base is configured to place the electric toothbrush and to charge the electric toothbrush. The base is configured to determine a reminding message displayed on the base according to the real-time monitoring data, wherein the reminding message is used to indicate a cleanliness degree corresponding to each dental region of the target user.

In one possible embodiment, the real-time monitoring data includes real-time pose data of the brush head, and the reminding message includes region reminding message for indicating a position of the brush head in a mouth of the target user; and the step of determining a reminding message displayed on the base according to the real-time monitoring data includes: determining real-time dental regions corresponding to the brush head according to the real-time pose data; and determining the region reminding message according to the real-time dental regions.

In one possible embodiment, the real-time monitoring data includes: cleaning duration data corresponding to the real-time dental region after the brush head leaves any one of the real-time dental regions, and the reminding message includes an unfinished reminding message or a finished reminding message corresponding to each of the real-time dental regions, wherein the unfinished reminding message corresponding to any one of the real-time dental regions is used to indicate that cleaning for the real-time dental region is not finished, and the finished reminding message corresponding to any one of the real-time dental regions is used to indicate that cleaning for the real-time dental region is finished; and the step of determining a reminding message displayed on the base according to the real-time monitoring data includes: determining the unfinished reminding message corresponding to the real-time dental region when the cleaning duration data corresponding to any one of the real-time dental regions does not satisfy a first preset duration range; or determining the finished reminding message corresponding to the real-time dental region when the cleaning duration data corresponding to any one of the real-time dental regions satisfies the first preset duration range.

In one possible embodiment, the reminding message includes a contact surface reminding message for indicating a real-time contact surface between the brush head and a tooth of the target user; and the step of determining a reminding message displayed on the base according to the real-time monitoring data includes: determining the contact surface reminding message for any one of the real-time dental regions according to the real-time pose data.

In one possible embodiment, the real-time dental regions include an upper left region of the mouth, a lower left region of the mouth, an upper right region of the mouth, and a lower right region of the mouth, and the real-time contact surface includes an inner side surface of the tooth, an outer side surface of the tooth, and a chewing surface of the tooth.

In one possible embodiment, the real-time monitoring data further includes: total brushing duration data, and the reminding message includes a first reminding message and a second reminding message, wherein the first reminding message is used to remind that the target user has finished cleaning for all teeth, and the second reminding message is used to remind that the target user has teeth that have not been cleaned; the step of determining a reminding message displayed on the base according to the real-time monitoring data includes: determining the first reminding message when cleaning for all dental regions is finished and the total brushing duration data satisfies a second preset duration range; or determining the second reminding message when cleaning for any one of the dental regions is unfinished or the total brushing duration data does not satisfy the second preset duration range.

In one possible embodiment, the real-time monitoring data includes: real-time pressure data for indicating a contact pressure between the brush head and the teeth of the target user, and the reminding message includes a third reminding message for reminding the target user to adjust a brushing strength; and the step of determining a reminding message displayed on the base according to the real-time monitoring data includes: determining the third reminding message when the real-time pressure data does not satisfy a preset pressure range.

In one possible embodiment, the method further includes: determining a corresponding number of times of the brush head has been used after the electric toothbrush is started; and determining a fourth reminding message when the number of uses reaches a preset maximum number of times, wherein the fourth reminding message is used to remind the target user to replace the brush head.

In one possible embodiment, the method further includes: transmitting the real-time monitoring data to a cloud data management platform corresponding to the electric toothbrush based on the wireless communication network; and determining a corresponding tooth brushing report of the target user according to the real-time monitoring data based on the cloud data management platform.

In one possible embodiment, the wireless communication network is a low energy Bluetooth communication network.

According to another aspect of the present disclosure, a control device of the electric toothbrush is provided, including: a real-time monitoring module, configured to determine real-time monitoring data during a brushing process of a target user based on the electric toothbrush, and to transmit the real-time monitoring data to a base corresponding to the electric toothbrush based on a wireless communication network, wherein the real-time monitoring data is used to reflect a movement condition of a brush head of the electric toothbrush, and the base is configured to place the electric toothbrush and to charge the electric toothbrush; and a reminding message determination module, configured to determine a reminding message displayed on the base according to the real-time monitoring data, wherein the reminding message is used to indicate a cleanliness degree corresponding to each dental region of the target user.

Another aspect of the present disclosure provides an electronic device, including: a processor, configured to store a memory for storing processor-executable instructions, wherein the processor is configured to realize the above method when executing the instructions stored in the memory.

According another aspect of the present disclosure, a non-volatile computer readable storage medium with computer program instructions stored thereon is provided, wherein the above method is realized when the computer program instructions are executed by a processor.

In the embodiments of the present disclosure, based on the electric toothbrush, the real-time monitoring data during the brushing process of the target user can be determined, and the real-time monitoring data is transmitted to the base based on the wireless communication network, wherein the real-time monitoring data is used to reflect the movement condition of the brush head of the electric toothbrush, and the base is configured to place the electric toothbrush and to charge the electric toothbrush, so as to realize the real-time monitoring for the brushing process of the target user, and to provide data support for improving the oral health of the user. According to the real-time monitoring data, the reminding message displayed on the base can be determined to indicate the corresponding cleanliness degree of each dental region of the target user, so as to guide the user to adjust the brushing pose and the brushing duration in real time, which improves the oral cleaning effect, and assists the user to develop a good brushing habit.

Other features and aspects of the present disclosure will be clear from the following detailed description of exemplary embodiments with reference to the drawings.

### BRIEF DESCRIPTION OF DRAWINGS

The drawings included in and forming a part of the specification together with the specification show exemplary embodiments, features, and aspects of the present disclosure, and are used to explain the principles of the present disclosure.

FIG. 1 shows a flow diagram of a control method of an electric toothbrush according to the embodiments of the present disclosure;

FIG. 2 shows a schematic diagram of a dental region according to the embodiments of the present disclosure;

FIG. 3 shows a schematic structure diagram of an electric toothbrush according to the embodiments of the present disclosure;

FIG. 4 shows a schematic diagram of a digital display film according to the embodiments of the present disclosure;

FIG. 5 shows a schematic diagram of a reminding message according to the embodiments of the present disclosure;

FIG. 6 shows a schematic diagram of a first reminding message according to the embodiments of the present disclosure;

FIG. 7 shows a schematic diagram of a second reminding message according to the embodiments of the present disclosure;

FIG. 8 shows a block diagram of a control device of an electric toothbrush according to the embodiments of the present disclosure; and

FIG. 9 shows a block diagram of an electronic device according to the embodiments of the present disclosure.

### DETAILED DESCRIPTION OF EMBODIMENTS

Various exemplary embodiments, features, and aspects of the present disclosure will be described in detail below with reference to the drawings. The same reference numbers in the drawings indicate components with the same or similar functions. Although various aspects of the embodiments are shown in the drawings, it is not necessary to draw the drawings to scale unless specifically noted.

The word “exemplary” is used herein to mean “used as an example, embodiment, or illustrative”. Any embodiment described herein as “exemplary” does not need to be interpreted as superior or better than other embodiments.

The term “and/or” herein is merely an association relationship for describing associated objects, and represents three relationships can exist. For example, A and/or B can represent three cases: A alone, both A and B, and B alone. Further, the term “at least one” herein represents any one of a plurality or any combination of at least two of a plurality, for example, including at least one of A, B, and C, and can represent that including any one or more components selected from the set consisting of A, B, and C.

Additionally, multiple specific details are given in the specific embodiments below in order to better illustrate the present disclosure. It should be understood by those skilled in the art that the present disclosure can also be performed without certain specific details. In some examples, the methods, means, components, and circuits well known to those skilled in the art are not described in detail in order to highlight the main thrust of the present disclosure.

The most important thing for protecting oral health is to develop a good brushing habit, such as mastering the normal brushing posture, strength, and duration. The electric toothbrush is a commonly used oral health care product today, which can help the user to improve the tooth cleanliness degree. However, the electric toothbrushes in the prior art cannot remind users when they brush their teeth incorrectly, which cannot help the user develop a good brushing habit.

In view of this, the embodiments of the present disclosure provide a control method of an electric toothbrush, which can determine a cleanliness degree of each dental region of a target user based on real-time monitoring data, and remind the target user in real time by a base corresponding to the electric toothbrush, so as to guide the user to adjust the brushing pose and the brushing duration, which improves the oral cleaning effect, and assists the user to develop the good brushing habit. The control method of the electric toothbrush in the embodiments of the present disclosure is described in detail below.

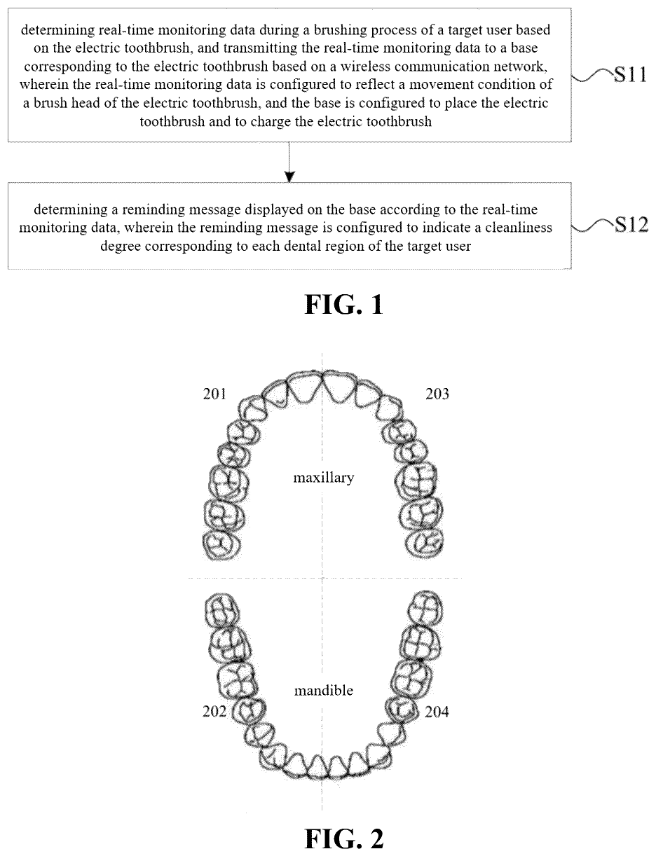

FIG. 1 shows a flow diagram of a control method of the electric toothbrush according to the embodiments of the present disclosure. As shown in FIG. 1, the control method of the electric toothbrush can be executed by an electronic device such as a terminal device or a server; the terminal device can be a user equipment (UE), a mobile device, a user terminal, a terminal, a cellular telephone, a cordless telephone, a personal digital assistant (PDA), a handheld device, a computing device, a vehicle device, and a wearable device; and the control method of the electric toothbrush can be realized by way of the processor invoking the computer-readable instructions stored in the memory, or the control method of the electric toothbrush can be executed by a server. As shown in FIG. 1, the control method of the electric toothbrush includes the following steps: S11˜S12.

S11: determining real-time monitoring data during a brushing process of a target user based on the electric toothbrush, and transmitting the real-time monitoring data to a base corresponding to the electric toothbrush based on a wireless communication network, wherein the real-time monitoring data is used to reflect a movement condition of a brush head of the electric toothbrush, and the base is configured to place the electric toothbrush and to charge the electric toothbrush.

By a sensor and other devices in the electric toothbrush, the movement condition of the brush head of the electric toothbrush can be monitored in real time during the brushing process of the target user, so as to determine real-time monitoring data. The specific content and form of the real-time monitoring data can be flexibly set according to the actual needs in use, for example, the real-time monitoring data can include real-time pose data of the brush head and real-time pressure data of the brush head, and the present disclosure does not specifically limit this herein. The specific form of the electric toothbrush can be referred to the embodiments in the related art, and it only needs to obtain the real-time monitoring data, wherein the present disclosure does not specifically limit this herein.

In an example, the electric toothbrush can include a sensor, such as a linear acceleration sensor, a gyroscope, and a pressure sensor, so as to monitor the movement condition of the brush head of the electric toothbrush.

After acquiring and determining the real-time monitoring data, the electric toothbrush can transmit the real-time monitoring data to its corresponding base by using the wireless communication network. The specific form of the wireless communication network can be flexibly set according to the actual needs in use, for example, it can be a Bluetooth communication network, a Wi-Fi network, or a cellular mobile communication network, wherein the present disclosure does not specifically limit this herein.

In one possible embodiment, the wireless communication network is a low energy Bluetooth communication network.

Preferably, the wireless communication network can be set as the low energy Bluetooth communication network for reducing the working energy consumption of the electric toothbrush and its base and improving the battery life of the electric toothbrush.

S12: determining a reminding message displayed on the base according to the real-time monitoring data, wherein the reminding message is used to indicate a cleanliness degree corresponding to each dental region of the target user.

After the base receives the real-time monitoring data from the electric toothbrush, the cleaning status corresponding to each dental region of the target user can be determined by performing the data analysis according to the real-time monitoring data, and the corresponding reminding message can be displayed on the base. The dental region herein can represent a preset region divided for the teeth of the target user according to the anatomical structure of the human teeth, and the contact mode between the brush head and the teeth, etc., wherein the specific division of the dental region can be flexibly set according to the actual use in use, and the present disclosure does not specifically limit this herein.

In one possible embodiment, the dental regions include an upper left region of the mouth, a lower left region of the mouth, an upper right region of the mouth, and a lower right region of the mouth.

Specifically, the mouth of the target user can be divided into four main regions, which are the upper left region of the mouth, the lower left region of the mouth, the upper right region of the mouth, and the lower right region of the mouth.

FIG. 2 shows a schematic diagram of a dental region according to the embodiments of the present disclosure. As shown in FIG. 2, the upper left region of the mouth 201 can include a left maxillary central incisor, a left maxillary lateral incisor, a left maxillary cuspid (canine), a left maxillary first premolar, a left maxillary second premolar, a left maxillary first molar, and a left maxillary second molar.

The lower left region of the mouth 202 can include a left mandibular central incisor, a left mandibular lateral incisor, a left mandibular cuspid (canine), a left mandibular first premolar, a left mandibular second premolar, a left mandibular first molar, and a left mandibular second molar.

The upper right region of the mouth 203 can include a right maxillary central incisor, a right maxillary lateral incisor, a right maxillary cuspid (canine), a right maxillary first premolar, a right maxillary second premolar, a right maxillary first molar, and a right maxillary second molar.

The lower right region of the mouth 204 can include a right mandibular central incisor, a right mandibular lateral incisor, a right mandibular cuspid (canine), a right mandibular first premolar, a right mandibular second premolar, a right mandibular first molar, and a right mandibular second molar.

The specific structure of the base can be flexibly set according to the actual needs in use, and the present disclosure does not specifically limit this herein. The specific content and form of the reminding message can be flexibly set according to the actual needs in use, and the present disclosure does not specifically limit this herein.

In one possible embodiment, the base includes a digital display film, an LED light group, and a voice reminding module, and the reminding message includes light indication information and the voice reminding message. The specific form of the LED light group can be flexibly set according to the actual needs in use, for example, the LED light group can be set to emit at least green, red, and white lights, and can flash at different frequencies. The present disclosure does not specifically limit this herein. The specific form of the voice reminding module can be referred to the embodiments in the related art, and the present disclosure does not specifically limit this herein.

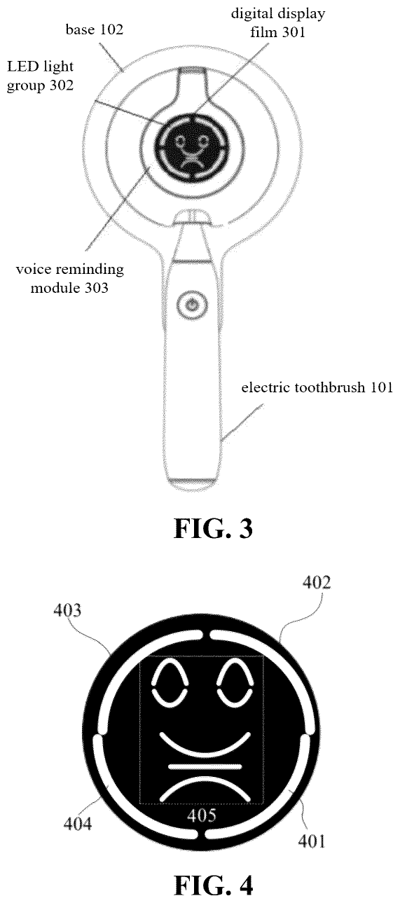

FIG. 3 shows a schematic structure diagram of the electric toothbrush according to the embodiments of the present disclosure. As shown in FIG. 3, the brush head of the electric toothbrush 101 is inserted into the base 102 and connected to the base 102; the base 102 is configured to place the electric toothbrush 101 and to charge the electric toothbrush 101; and the base 102 includes the digital display film 301, the LED light group 302, and the voice reminding module 303.

FIG. 4 shows a schematic diagram of the digital display film according to the embodiments of the present disclosure. As shown in FIG. 4, the digital display film includes an indication region 401, an indication region 402, an indication region 403, an indication region 404, and an expression display region 405.

The base 102 can adjust the working state of the LED light group 302 according to the real-time operation state of the electric toothbrush 101 and the real-time monitoring data, so that the corresponding region in the digital display film 301 can emit light and the corresponding light indication information can be determined, and at the same time the voice reminding module is controlled to emit the voice reminding message.

In the embodiments of the present disclosure, based on the electric toothbrush, the real- time monitoring data during the brushing process of the target user can be determined, and the real-time monitoring data is transmitted to the base based on the wireless communication network, wherein the real-time monitoring data is used to reflect the movement condition of the brush head of the electric toothbrush, and the base is configured to place the electric toothbrush and to charge the electric toothbrush, so as to realize the real-time monitoring for the brushing process of the target user, and to provide data support for improving the oral health of the user. According to the real-time monitoring data, the reminding message displayed on the base can be determined to indicate the corresponding cleanliness degree of each dental region of the target user, so as to guide the user to adjust the brushing pose and the brushing duration in real time, which improves the oral cleaning effect, and assists the user to develop a good brushing habit.

In one possible embodiment, the real-time monitoring data includes real-time pose data of the brush head, and the reminding message includes region reminding message for indicating a position of the brush head in a mouth of the target user; and the step of determining the reminding message displayed on the base according to the real-time monitoring data includes: determining real-time dental regions corresponding to the brush head according to the real-time pose data; and determining the region reminding message according to the real-time dental regions.

The real-time pose data of the brush head can be used to represent a real-time position and posture of the brush head in the mouth of the target user. The specific content and form of the real-time pose data can be flexibly set according to the actual needs in use, and the present disclosure does not specifically limit this herein.

The real-time dental region corresponding to the brush head can be determined according to the real-time pose data, wherein the real-time dental region corresponding to the brush head can represent any one of the foregoing dental regions.

Based on the real-time dental region corresponding to the brush head, the reminding message corresponding to the real-time dental region can be determined and displayed on the base so that the target user can accurately understand which dental region is currently being cleaned. The specific form of the reminding message, and the specific method of the base displaying the reminding message can be flexibly set according to the actual needs in use, and the present disclosure does not specifically limit this herein.

The above base 102 includes the digital display film, the LED light group, and the voice reminding module, and the digital display film includes the indication region 401, the indication region 402, the indication region 403, the indication region 404, and the expression display region 405.

Each indication region in the digital display film can correspond to one dental region of the target user. Specifically, the indication region 401 can correspond to the lower right region of the mouth of the target user; the indication region 402 can correspond to the upper right region of the mouth of the target user; the indication region 403 can correspond to the upper left region of the mouth of the target user; and the indication region 404 can correspond to the lower left region of the mouth of the target user.

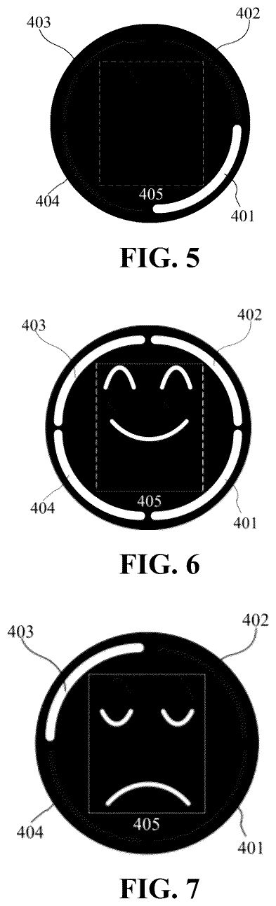

FIG. 5 shows a schematic diagram of a reminding message according to the embodiments of the present disclosure. As shown in FIG. 5, when the real-time dental region is determined to the lower right region of the mouth according to the real-time pose data of the brush head, the base 102 can control the LED light group to light the indication region 401 of the digital display film as a region reminding message corresponding to the lower right region of the mouth.

Through the above process, the current cleaned dental region can be accurately indicated, so that the target user can understand the cleaning progress of teeth in real time, thereby avoiding omissions in the brushing process. This improves the cleanliness degree of teeth of the target user and helps the target user develop a good brushing habit.

In one possible embodiment, the real-time monitoring data includes: cleaning duration data corresponding to the real-time dental region after the brush head leaves any one of the real-time dental regions, and the reminding message includes an unfinished reminding message or a finished reminding message corresponding to each real-time dental region, wherein the unfinished reminding message corresponding to any one of the real-time dental regions is used to indicate that cleaning for the real-time dental region is not finished, and the finished reminding message corresponding to any one of the real-time dental regions is used to indicate that cleaning for the real-time dental region is finished; and the step of determining the reminding message displayed on the base according to the real-time monitoring data includes: determining the unfinished reminding message corresponding to the real-time dental region when the cleaning duration data corresponding to any one of the real-time dental regions does not satisfy a first preset duration range; or determining the finished reminding message corresponding to the real-time dental region when the cleaning duration data corresponding to any one of the real-time dental regions satisfies the first preset duration range.

In order to ensure that the bacteria in the teeth and mouth are adequately cleaned, and to solve oral problems such as the enamel wear and the gum overstimulation, the length of the brushing duration needs to be controlled within a reasonable range. When the brush head leaves any one of the real-time dental regions, it can be determined that the cleaning for the real-time dental region is finished. At this time, the cleaning duration data corresponding to the real-time dental region can be determined by using the electric toothbrush, and the cleaning duration data can be transmitted to the base by the wireless communication network.

For any one of the real-time dental regions, the unfinished reminding message corresponding to the real-time dental region can be determined and displayed on the base when the cleaning duration data corresponding to the real-time dental region does not satisfy the first preset duration range. The specific value of the first preset duration range can be set flexibly according to the actual needs in use, e.g., it can be set as 30s to 40s, and the present disclosure does not specifically limit this herein; and the specific form of the unfinished reminding message can be flexibly set according to the actual needs in use, and the present disclosure does not specifically limit this herein.

For any one of the real-time dental regions, the finished reminding message corresponding to the real-time dental region can be determined and displayed on the base when the cleaning duration data corresponding to the real-time dental region satisfies the first preset duration range. The specific form of the finished reminding message can be flexibly set according to the actual needs in use, and the present disclosure does not specifically limit this herein.

Through the above process, the current cleaned dental region can be accurately indicated, so that the target user can understand the cleaning progress of teeth in real time, thereby avoiding omissions in the brushing process, which can improve the cleanliness degree of teeth of the target user, and help the target user develop the good brushing habit.

In one possible embodiment, the reminding message includes a contact surface reminding message for indicating a real-time contact surface between the brush head and a tooth of the target user; and the step of determining the reminding message displayed on the base according to the real-time monitoring data includes: determining the contact surface reminding message for any one of the real-time dental regions according to the real-time pose data.

For any one of the real-time dental regions, the real-time contact surface between the brush head and the tooth of the target user in the real-time dental region can be determined and displayed on the base according to the real-time pose data. The specific form of the real-time contact surface can be flexibly set according to the actual needs in use, and the present disclosure does not specifically limit this herein.

In one possible embodiment, the real-time contact surface includes an inner side surface of the tooth, an outer side surface of the tooth, and a chewing surface of the tooth.

For any one of the real-time contact surfaces, the contact surface reminding message corresponding to the real-time contact surface can be determined and displayed on the base, so that the target user accurately understands the current cleaning position, so as to improve the cleanliness degree of teeth of the target user. The specific form of the contact surface reminding message can be flexibly set according to the actual needs in use, and the present disclosure does not specifically limit this herein.

The above base 102 includes the digital display film, the LED light group, and the voice reminding module, and the digital display film includes the indication region 401, the indication region 402, the indication region 403, the indication region 404, and the expression display region 405.

When the base 102 determines the real-time contact surface as the inner side surface of the tooth according to the real-time pose data of the brush head, the base 102 can control the corresponding light mode of the LED light group to be a first mode to serve as the contact surface reminding message corresponding to the inner side surface of the tooth; when the base 102 determines the real-time contact surface as the chewing surface of the tooth according to the real-time pose data of the brush head, the base 102 can control the corresponding light mode of the LED light group to be a second mode to serve as the contact surface reminding message corresponding to the chewing surface of the tooth; and when the base 102 determines the real-time contact surface as the outer side surface of the tooth according to the real-time pose data of the brush head, the base 102 can control the corresponding light mode of the LED light group to be a third mode to serve as the contact surface reminding message corresponding to the outer side surface of the tooth. The specific form of the light mode can be flexibly set according to the actual needs in use, for example, the LED light group can be set to flash at different frequencies when it is in different light-emitting modes, and the present disclosure does not specifically limit this herein.

Through the above process, the real-time contact surface between the brush head and the teeth of the target user can be accurately indicated, so that the target user further controls the cleaning progress of teeth, thereby avoiding omissions in the brushing process, which can improve the cleanliness degree of teeth of the target user.

In one possible method, the region reminding message and the contact surface reminding message can also be automatically displayed according to a preset mode and displayed on the base, so that the target user can finish the brushing process according to instructions of the region reminding message and the contact surface reminding message.

The preset mode herein can include an order for displaying the region reminding message and the contact surface reminding message, and a display duration of each region reminding message and contact surface reminding message. The specific content of the preset mode can be flexibly set according to the actual needs in use, and the present disclosure does not specifically limit this.

In an example, after the electric toothbrush is started, the region reminding message corresponding to the lower right region of the mouth, the region reminding message corresponding to the upper right region of the mouth, the region reminding message corresponding to the upper left region of the mouth, and the region reminding message corresponding to the lower left region of the mouth can be displayed sequentially on the base corresponding to the electric toothbrush, and each region reminding message is controlled to be displayed for 30s; and for any one of the region reminding message, the contact surface reminding message corresponding to the outer side surface of the teeth, the contact surface reminding message corresponding to the chewing surface of the tooth, and the contact surface reminding message corresponding to the inner side surface of the teeth is displayed sequentially, and each contact surface reminding message is controlled to be displayed for 10s.

Through the above process, the brushing process of the target user can be guided by the preset mode, so as to improve the cleanliness degree of teeth of the target user, and to help the target user develop the good brushing habit at the same time.

In one possible embodiment, the real-time monitoring data further includes total brushing duration data, and the reminding message includes a first reminding message and a second reminding message, wherein the first reminding message is used to remind that the target user has finished cleaning for all teeth, and the second reminding message is used to remind that the target user has teeth that have not been cleaned; and the step of determining the reminding message displayed on the base according to the real-time monitoring data includes: determining the first reminding message when cleaning for all dental regions is finished and the total brushing duration data satisfies a second preset duration range; or determining the second reminding message when cleaning for any one of the dental regions is unfinished or the total brushing duration data does not satisfy the second preset duration range.

The total brushing duration data can indicate the total time consumed by the target user to finish a brushing process. The specific method for determining the total brushing duration data can be flexibly set according to the actual needs in use, for example, it can be determined by accumulating the cleaning duration data corresponding to each dental region, or it can be determined by a time interval between startup and shutdown corresponding to the electric toothbrush, and the present disclosure does not specifically limit this herein.

When the cleaning for all dental regions has finished and the total brushing duration data satisfies the second preset duration range, the first reminding message can be determined and displayed on the base, so as to remind the target user that the cleaning for all teeth has finished. The specific form of the first reminding message can be flexibly set according to the actual needs in use, and the present disclosure does not specifically limit this herein.

The above base 102 includes the digital display film, the LED light group, and the voice reminding module, and the digital display film includes the indication region 401, the indication region 402, the indication region 403, the indication region 404, and the expression display region 405.

FIG. 6 shows a schematic diagram of a first reminding message according to the embodiments of the present disclosure. As shown in FIG. 6, when the cleaning for all dental regions has finished and the total brushing duration data satisfies the second preset duration range, the base 102 can control the LED light group to light all indication regions of the digital display film, and control the expression display region of the digital display film to display a smile face expression as the first reminding message.

When cleaning for any one of the dental regions is unfinished or the total brushing duration data does not satisfy the second preset duration range, the second reminding message can be determined and displayed on the base, so as to remind the target user that there are tecth that have not been cleaned. The specific form of the second reminding message can be flexibly set according to the actual needs in use, and the present disclosure does not specifically limit this hercin.

FIG. 7 shows a schematic diagram of the second reminding message according to the embodiments of the present disclosure. As shown in FIG. 7, when the cleaning for the upper left region of the mouth is not finished, the base 102 can control the LED light group to light the indication region 403, and control the expression display region of the digital display film to display a cry face expression as the second reminding message.

Through the above process, the target user can rebrush the dental region that has not cleaned enough according to the whole condition of the brushing process and the reminding message, so as to improve the cleanliness degree of teeth of the target user, and to help the target user develop the good brushing habit.

In one possible embodiment, the real-time monitoring data includes: real-time pressure data for indicating a contact pressure between the brush head and the teeth of the target user; and the reminding message includes: a third reminding message for reminding the target user to adjust a brushing strength; and the step of determining the reminding message displayed on the base according to the real-time monitoring data includes: determining the third reminding message when the real-time pressure data does not satisfy a preset pressure range.

Specifically, the real-time pressure data can be used to indicate the contact pressure between the brush head and the teeth of the target user to reflect the brushing strength of the target user.

When the real-time pressure data does not satisfy the preset pressure range, the third reminding message can be determined and displayed on the base, so as to indicate the target user to adjust the brushing strength. The specific value of the preset pressure range can be set flexibly according to the actual needs in use, for example, it can be set from 0.9N (Newton) to 1.4N, and the present disclosure does not specifically limit this herein. The specific form of the third reminding message can be flexibly set according to the actual needs in use, and the present disclosure does not specifically limit this herein.

The above base 102 includes the digital display film, the LED light group, and the voice reminding module, and the digital display film includes the indication region 401, the indication region 402, the indication region 403, the indication region 404, and the expression display region 405.

When the real-time pressure data does not satisfy the preset pressure range, the base 102 can control the LED light group to emit the red light and flash, and at the same time control the voice reminding module to remind the target user to adjust the brushing strength, which is taken as the third reminding message.

In one possible embodiment, the method further includes: determining a corresponding number of times of the brush head has been used after the electric toothbrush is started; and determining a fourth reminding message when the number of uses reaches a preset maximum number of times, wherein the fourth reminding message is used to remind the target user to replace the brush head.

After multiple use, the roots of the bristles of the brush head of the electric toothbrush will accumulate stains, and the bristles will be soft and deformed, which leads to a decline in its cleaning effect. Therefore, the brush head of the electric toothbrush needs to be replaced regularly. However, the user usually will not specially record how many times a brush head has been used or how long it has been used, and the electric toothbrush in the prior art also lacks the statistics of the relevant data, which cannot automatically remind the user to replace the brush head in real time.

In view of this, the corresponding number of times of the brush head has been used can be determined after the electric toothbrush is started, and the number of usages is transmitted to the base by the wireless communication network. The specific manner of the electric toothbrush determining the corresponding number of times of the brush head has been used can be referred to embodiments in prior arts, and the present disclosure does not specifically limit this herein.

In one possible embodiment, the electric toothbrush includes an electronic counter, wherein the electronic counter can count each time the electric toothbrush is started, so as to determine the number of starting times of the electric toothbrush, and the electric toothbrush can determine the number of uses of the brush head according to the number of starting times of the electric toothbrush.

When the number of uses reaches a preset maximum number of times, a fourth reminding message can be determined and displayed on the base, so as to remind the target user to replace the brush head. The specific form of the fourth reminding message can be flexibly set according to the actual needs in use, and the present disclosure does not specifically limit this herein.

Taking the above base 102 including the digital display film, the LED light group, and the voice reminding module as an example, When the base 102 determines that the number of uses has reached the preset maximum number of times, it can control the LED light group to flash to alarm with red lights, and control the voice reminding module to play a voice reminding message for replacing the brush head.

In one possible embodiment, the method further includes: transmitting the real-time monitoring data to a cloud data management platform corresponding to the electric toothbrush based on the wireless communication network; and determining a corresponding tooth brushing report of the target user according to the real-time monitoring data based on the cloud data management platform.

Specifically, the data can be transmitted by the cloud data management platform corresponding to the electric toothbrush via the wireless communication network. The specific form of the cloud data management platform can be flexibly set according to the actual needs in use, and the present disclosure does not specifically limit this herein. Preferably, the cloud data management platform can be a software program bound with the identity information of the target user and the device identification corresponding to the electric toothbrush.

The real-time monitoring data can be transmitted to the cloud data management platform by using the wireless communication network. The cloud data management platform can store the real-time monitoring data for casy query and review by the target user, and the corresponding tooth brushing report for the target user is determined according to the real-time monitoring data. Through the brushing report, the brushing habit of the target user can be further statistically analyzed. The specific content of the tooth brushing report can be flexibly set according to the actual needs in use, and the present disclosure does not specifically limit this herein.

In the embodiments of the present disclosure, based on the electric toothbrush, the real-time monitoring data during the brushing process of the target user can be determined, and the real-time monitoring data is transmitted to the base based on the wireless communication network, wherein the real-time monitoring data is used to reflect the movement condition of the brush head of the electric toothbrush, and the base is configured to place the electric toothbrush and to charge the electric toothbrush, so as to realize the real-time monitoring for the brushing process of the target user, and to provide data support for improving the oral health of the user. According to the real-time monitoring data, the reminding message displayed on the base can be determined to indicate the corresponding cleanliness degree of cach dental region of the target user, so as to guide the user to adjust the brushing pose and the brushing duration in real time, which improves the oral cleaning effect, and assists the user to develop the good brushing habit.

It is understood that each of the above method embodiments mentioned in the present disclosure can be combined with each other to form a combined embodiment without violating the logic of the principle. Limited by space, the present disclosure will not be repeated. It will be understood by those skilled in the art that in the above method of the specific embodiments, the specific order of execution of the steps shall be determined by their function and possible internal logic.

In addition, the present disclosure further provides a control device of the electric toothbrush, an electronic device, a computer readable storage medium, and a program, and all of the above can be used to realize any one of the control methods of the electric toothbrushes provided by the present disclosure. The corresponding technical solutions and descriptions refer to the corresponding record in the method section, and will not be repeated.

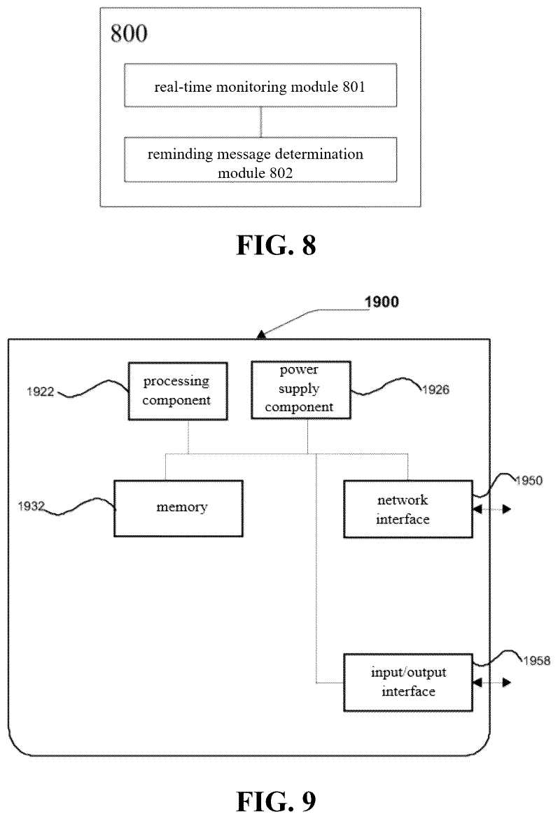

FIG. 8 shows a block diagram of a control device of the electric toothbrush according to the embodiments of the present disclosure. As shown in FIG. 8, the device 800 includes:

a real-time monitoring module 801, configured to determine the real-time monitoring data during the brushing process of the target user based on the electric toothbrush, and to transmit the real-time monitoring data to the base corresponding to the electric toothbrush based on the wireless communication network, wherein the real-time monitoring data is used to reflect the movement condition of the brush head of the electric toothbrush, and the base is configured to place the electric toothbrush and to charge the electric toothbrush; and

a reminding message determination module 802, configured to determine the reminding message displayed on the base according to the real-time monitoring data, wherein the reminding message is used to indicate a cleanliness degree corresponding to each dental region of the target user.

In one possible embodiment, the real-time monitoring data includes real-time pose data of the brush head, and the reminding message includes region reminding message for indicating a position of the brush head in the mouth of the target user. The reminding message determination module 802 is specifically configured to determine real-time dental regions corresponding to the brush head according to the real-time pose data, and to determine the region reminding message according to the real-time dental regions.

In one possible embodiment, the real-time monitoring data includes the cleaning duration data corresponding to the real-time dental region after the brush head leaves any one of the real-time dental regions, and the reminding message includes the unfinished reminding message or the finished reminding message corresponding to each real-time dental region, wherein the unfinished reminding message corresponding to any one of the real-time dental regions is used to indicate that the cleaning for the real-time dental region is not finished, and the finished reminding message corresponding to any one of the real-time dental regions is configured to indicate that the cleaning for the real-time dental region is finished. The reminding message determination module 802 is specifically configured to determine the unfinished reminding message corresponding to the real-time dental region when the cleaning duration data corresponding to any one of the real-time dental regions does not satisfy the first preset duration range, or determine the finished reminding message corresponding to the real-time dental region when the cleaning duration data corresponding to any one of the real-time dental regions satisfies the first preset duration range.

In one possible embodiment, the reminding message includes the contact surface reminding message for indicating the real-time contact surface between the brush head and the tooth of the target user. The reminding message determination module 802 is specifically configured to determine the contact surface reminding message for any one of the real-time dental regions according to the real-time pose data.

In one possible embodiment, the real-time dental regions include the upper left region of the mouth, the lower left region of the mouth, the upper right region of the mouth, and the lower right region of the mouth; and the real-time contact surface includes the inner side surface of the tooth, the outer side surface of the tooth, and the chewing surface of the tooth.

In one possible embodiment, the real-time monitoring data further includes: total brushing duration data, and the reminding message includes the first reminding message and the second reminding message, wherein the first reminding message is used to remind that the target user has finished cleaning for all teeth, and the second reminding message is used to remind that the target user has the tooth that has not been cleaned. The reminding message determination module 802 is specifically configured to: determine the first reminding message when the cleaning for all dental regions is finished and the total brushing duration data satisfies the second preset duration range; or

determine the second reminding message when cleaning for any one of the dental regions is unfinished or the total brushing duration data does not satisfy the second preset duration range.

In one possible embodiment, the real-time monitoring data includes: real-time pressure data for indicating the contact pressure between the brush head and the teeth of the target user; and the reminding message includes: the third reminding message for reminding the target user to adjust the brushing strength. The reminding message determination module 802 is specifically configured to: determine the third reminding message when the real-time pressure data does not satisfy the preset pressure range.

In one possible embodiment, the device 800 further includes a usage count monitoring module for determining a corresponding number of times of the brush head has been used after the electric toothbrush is started; and determining the fourth reminding message when the number of uses reaches the preset maximum number of times, wherein the fourth reminding message is used to remind the target user to replace the brush head.

In one possible implementation, the device 800 further includes a cloud data management module for transmitting the real-time monitoring data to the cloud data management platform corresponding to the electric toothbrush based on the wireless communication network; and determining the corresponding tooth brushing report of the target user according to the real-time monitoring data based on the cloud data management platform.

In one possible embodiment, the wireless communication network is a low energy Bluetooth communication network.

In some embodiments, the device provided by embodiments of the present disclosure has functions or contains modules that can be used to perform methods described in the method embodiments above. The specific embodiment can refer to the description of the method embodiments above, and it will not be repeated herein for the sake of brevity.

The embodiments of the present disclosure further provide a computer readable storage medium with computer program instructions stored thereon, wherein the above method is realized when the computer program instructions are executed by a processor. The computer readable storage medium can be a volatile or non-volatile computer-readable storage medium.

The embodiments of the present disclosure further provide an electronic device, including a processor, configured to store a memory for storing processor-executable instructions, wherein the processor is configured to realize the above method when executing the instructions stored in the memory.

FIG. 9 shows a block diagram of an electronic device according to the embodiments of the present disclosure, for example, the device 1900 can be provided as a server or a terminal device. Referring to FIG. 9, the device 1900 includes a processing component 1922, which further includes one or more processors, and a memory resource represented by the memory 1932 for storing instructions that can be executed by the processing component 1922, such as an application program. The application program stored in the memory 1932 can include one or more modules, wherein each module corresponds to a set of instructions. In addition, the processing component 1922 is configured to execute instructions to perform the method described above.

The device 1900 can further include a power supply component 1926 configured to perform the power management of the device 1900, a wired or wireless network interface 1950 configured to connect the device 1900 to the network, and an input/output interface 1958 (I/O interface). The device 1900 can operate an operating system stored in the memory 1932, such as Windows Server™, Mac OS X™, Unix™, Linux™, or FreeBSD™.

In exemplary embodiments, a non-volatile computer readable storage medium is further provided, such as the memory 1932 including computer program instructions. The above computer program instructions can be executed by the processing component 1922 of the device 1900, so as to finish the above methods.

The present disclosure can be a system, method, and/or computer program product. The computer program product can include a computer readable storage medium containing computer-readable program instructions, so that the processor realizes various aspects of the present disclosure.

The computer readable storage medium can be a tangible device that can hold and store instructions used by an instruction execution device. The computer readable storage medium can be, for example, but is not limited to an electrical storage device, a magnetic storage device, an optical storage device, an electromagnetic storage device, a semiconductor storage device, or any proper combination of the above. More specific examples (a non-exhaustive list) of the computer readable storage medium include: a portable computer disk, hard disk, random access memory (RAM), read-only memory (ROM), crasable programmable read-only memory (EPROM or flash memory), static random access memory (SRAM), portable compact disk read-only memory (CD-ROM), digital versatile disk (DVD), memory stick, floppy disk, mechanical coding device storing punched card of instructions or a convex structure in a groove thereon, and any proper combination of the above. The computer readable storage medium used herein is not interpreted as the instantaneous signal itself, such as radio waves or other freely propagating electromagnetic waves, electromagnetic waves propagated through waveguides or other transmission media (e.g., light pulses passing through fiber optic cables), or electrical signals transmitted by electrical wires.

The computer-readable program instructions described herein can be downloaded from the computer readable storage medium to each computing/processing device or to an external computer or external storage device via a network, such as the Internet, local area network, wide area network, and/or wireless network. The network can include the copper transmission cable, fiber optic transmission, wireless transmission, router, firewall, switch, gateway computer, and/or edge server. The network adapter card or network interface in each computing/processing device receives computer-readable program instructions from the network and forwards the computer-readable program instructions for storage in the computer readable storage medium in each computing/processing device.

The computer program instructions for performing the operations of the present disclosure can be the assembly instruction, instruction set architecture (ISA) instruction, machine instruction, machine-related instruction, microcode, firmware instruction, state setting data, or the source code or object code written by one or a combination of more of programming languages. The programming language includes the object-oriented programming language, such as Smalltalk, and C++, and the conventional procedural programming language, such as the “C” language, and similar programming languages. The computer-readable program instructions can be entirely executed on the computer of the user, partially executed on the computer of the user, executed as a stand-alone software package, partially executed on the computer of the user and partially executed on a remote computer, or entirely executed on a remote computer or server. In the case of a remote computer, the remote computer can be connected to the computer of the user by any kind of network, including a local area network (LAN) or a wide area network (WAN), or it can be connected to an external computer (e.g., connected by the Internet provided by the Internet service provider). In some embodiments, the electronic circuit, such as the programmable logic circuits, field programmable gate array (FPGA), or programmable logic array (PLA), is personalized by using the state information of the computer-readable program instruction. The electronic circuit can execute the computer-readable program instruction, so as to realize all aspects of the present disclosure.

Aspects of the present disclosure are described herein with reference to flowcharts and/or block diagrams of the method, device (system), and computer program product based on the embodiments of the present disclosure. It should be understood that each block diagram of the flowchart and/or block diagram, and the combination of each block in the flowchart and/or block diagram can all be realized by computer-readable program instructions.

These computer-readable program instructions can be provided to a general-purpose computer, a special-purpose computer, or a processor of other programmable data processing devices, so as to produce a machine, so that these instructions produce a device realizing functions/actions specified in one or more blocks in flowcharts and/or block diagrams when executed by the processor of a computer or other programmable data processing devices. These computer-readable program instructions can also be stored in the computer readable storage medium and these instructions cause the computer, programmable data processing device, and/or other devices to work in a particular manner, so that the computer-readable medium storing instructions include a manufacturing product that includes instructions for realizing all aspects of a function/action specified in one or more blocks in the flowchart and/or block diagram.

It can also load the computer-readable program instructions onto the computer, other programmable data processing devices, or other devices, so that the computer, other programmable data processing devices, or other devices perform a series of operational steps, so as to generate a computer realization process, so that the instructions performed on the computer, other programmable data processing device, or other devices realizes the function/action specified in one or more blocks in the flowchart and/or block diagram.

The flowchart and block diagram in the drawings show the architecture, functionality, and operation that may be realized by the system, method, and computer program product according to the plurality of embodiments of the present disclosure. At this point, each block in the flow schematic diagram or block schematic diagram may represent a module, program segment, or a part of instructions, and the module, program segment, or a part of the instructions includes one or more executable instructions for realizing specified logical functions. In some embodiments as the replacement, the functions indicated in the blocks may also occur in a different order than those indicated in the drawings. For example, two consecutive blocks can actually be executed essentially in parallel, and they can sometimes be executed in reverse order, which depends on the functions involved. It is also noted that each block in the block diagram and/or flow schematic diagram, and combinations of boxes in the block diagrams and/or flow schematic diagrams can be realized by a dedicated hardware-based system that executes the specified function or action, or can be realized by a combination of the dedicated hardware and computer instructions.

Various embodiments of the present disclosure have been described above, and the foregoing description is exemplary, not exhaustive, and not limited to the disclosed embodiments. Without deviating from the scope and spirit of the various embodiments illustrated, many modifications and changes are apparent to a person of ordinary skill in the art. The terms used herein are chosen to best explain the principles, practical applications, or the technical improvements in the market, or to make other persons of ordinary skill in the art understand each embodiment disclosed herein.

Various embodiments of the present disclosure have been described above, and the foregoing description is exemplary, not exhaustive, and not limited to the disclosed embodiments. Without deviating from the scope and spirit of the various embodiments illustrated, many modifications and changes are apparent to a person of ordinary skill in the art. The terms used herein are chosen to best explain the principles, practical applications, or the technical improvements in the market, or to make other persons of ordinary skill in the art understand each embodiment disclosed herein.

1. A control method of an electric toothbrush, comprising
determining real-time monitoring data during a brushing process of a target user based on the electric toothbrush, and transmitting the real-time monitoring data to a base corresponding to the electric toothbrush based on a wireless communication network, wherein the real-time monitoring data is used to reflect a movement condition of a brush head of the electric toothbrush, and the base is configured to place the electric toothbrush and to charge the electric toothbrush; and
determining a reminding message displayed on the base according to the real-time monitoring data, wherein the reminding message is used to indicate a cleanliness degree corresponding to each dental region of the target user.

2. The method according to claim 1, wherein the real-time monitoring data comprises real-time pose data of the brush head, and the reminding message comprises region reminding message for indicating a position of the brush head in a mouth of the target user; and
the step of determining a reminding message displayed on the base according to the real-time monitoring data comprises:
determining real-time dental regions corresponding to the brush head according to the real-time pose data; and
determining the region reminding message according to the real-time dental regions.

3. The method according to claim 2, wherein the real-time monitoring data comprises:
cleaning duration data corresponding to the real-time dental region after the brush head leaves any one of the real-time dental regions; the reminding message comprises an unfinished reminding message or a finished reminding message corresponding to each of the real-time dental regions, wherein the unfinished reminding message corresponding to any one of the real-time dental regions is used to indicate that cleaning for the real-time dental region is not finished, and the finished reminding message corresponding to any one of the real-time dental regions is used to indicate that the cleaning for the real-time dental region is finished; and the step of determining the reminding message displayed on the base according to the real-time monitoring data comprises:
determining the unfinished reminding message corresponding to the real-time dental region when the cleaning duration data corresponding to any one of the real-time dental regions does not satisfy a first preset duration range; or
determining the finished reminding message corresponding to the real-time dental region when the cleaning duration data corresponding to any one of the real-time dental regions satisfies the first preset duration range.

4. The method according to claim 2, wherein the reminding message comprises a contact surface reminding message for indicating a real-time contact surface between the brush head and a tooth of the target user; and
the step of determining the reminding message displayed on the base according to the real-time monitoring data comprises:
determining the contact surface reminding message for any one of the real-time dental regions according to the real-time pose data.

5. The method according to claim 4, wherein the real-time dental regions comprise an upper left region of the mouth, a lower left region of the mouth, an upper right region of the mouth, and a lower right region of the mouth, and the real-time contact surface comprises an inner side surface of a tooth, an outer side surface of the tooth, and a chewing surface of the tooth.

6. The method according to claim 2, wherein the real-time monitoring data further comprises total brushing duration data, and the reminding message comprises a first reminding message and a second reminding message, wherein
the first reminding message is used to remind that the target user has finished cleaning for all teeth, and the second reminding message is used to remind that the target user has teeth that have not been cleaned; and
the step of determining the reminding message displayed on the base according to the real-time monitoring data comprises:
determining the first reminding message when the cleaning for all dental regions is finished and the total brushing duration data satisfies a second preset duration range; or
determining the second reminding message when the cleaning for any one of the dental regions is unfinished or the total brushing duration data does not satisfy the second preset duration range.

7. The method according to claim 1, wherein the real-time monitoring data comprises: real-time pressure data for indicating a contact pressure between the brush head and the teeth of the target user; and the reminding message comprises: a third reminding message for reminding the target user to adjust a brushing strength; and
the step of determining the reminding message displayed on the base according to the real-time monitoring data comprises:
determining the third reminding message when the real-time pressure data does not satisfy a preset pressure range.

8. The method according to claim 1, wherein the method further comprises:
determining a corresponding number of times of the brush head has been used after the electric toothbrush is started; and
determining a fourth reminding message when the number of uses reaches a preset maximum number of times, wherein the fourth reminding message is used to remind the target user to replace the brush head.

9. The method according to claim 1, wherein the method further comprises:
transmitting the real-time monitoring data to a cloud data management platform corresponding to the electric toothbrush based on the wireless communication network; and
determining a corresponding tooth brushing report of the target user according to the real-time monitoring data based on the cloud data management platform.

10. The method according to claim 1, wherein the wireless communication network is a low energy Bluetooth communication network.

11. A control device of an electric toothbrush, comprising:
a real-time monitoring module, configured to determine real-time monitoring data during a brushing process of a target user based on the electric toothbrush, and to transmit the real-time monitoring data to a base corresponding to the electric toothbrush based on a wireless communication network, wherein the real-time monitoring data is used to reflect a movement condition of a brush head of the electric toothbrush, and the base is configured to place the electric toothbrush and to charge the electric toothbrush; and
a reminding message determination module, configured to determine a reminding message displayed on the base according to the real-time monitoring data, wherein the reminding message is used to indicate a cleanliness degree corresponding to each dental region of the target user.

12. An electronic device, comprising:
a processor, configured to store a memory for storing processor-executable instructions, wherein
the processor is configured to realize the method according to claim 1 when executing the instructions stored in the memory.

13. A non-volatile computer readable storage medium with computer program instructions stored thereon, wherein the method according to claim 1 is realized when the computer program instructions are executed by a processor.

14. The method according to claim 7, wherein the real-time monitoring data comprises real-time pose data of the brush head, and the reminding message comprises region reminding message for indicating a position of the brush head in a mouth of the target user; and
the step of determining a reminding message displayed on the base according to the real-time monitoring data comprises:
determining real-time dental regions corresponding to the brush head according to the real-time pose data; and
determining the region reminding message according to the real-time dental regions.

15. The method according to claim 14, wherein the real-time monitoring data comprises:
cleaning duration data corresponding to the real-time dental region after the brush head leaves any one of the real-time dental regions; the reminding message comprises an unfinished reminding message or a finished reminding message corresponding to each of the real-time dental regions, wherein the unfinished reminding message corresponding to any one of the real-time dental regions is used to indicate that cleaning for the real-time dental region is not finished, and the finished reminding message corresponding to any one of the real-time dental regions is used to indicate that the cleaning for the real-time dental region is finished; and
the step of determining the reminding message displayed on the base according to the real-time monitoring data comprises:
determining the unfinished reminding message corresponding to the real-time dental region when the cleaning duration data corresponding to any one of the real-time dental regions does not satisfy a first preset duration range; or
determining the finished reminding message corresponding to the real-time dental region when the cleaning duration data corresponding to any one of the real-time dental regions satisfies the first preset duration range.

16. The method according to claim 8, wherein the real-time monitoring data comprises real-time pose data of the brush head, and the reminding message comprises region reminding message for indicating a position of the brush head in a mouth of the target user; and
the step of determining a reminding message displayed on the base according to the real-time monitoring data comprises:
determining real-time dental regions corresponding to the brush head according to the real-time pose data; and
determining the region reminding message according to the real-time dental regions.

17. The method according to claim 16, wherein the real-time monitoring data comprises:
cleaning duration data corresponding to the real-time dental region after the brush head leaves any one of the real-time dental regions; the reminding message comprises an unfinished reminding message or a finished reminding message corresponding to each of the real-time dental regions, wherein the unfinished reminding message corresponding to any one of the real-time dental regions is used to indicate that cleaning for the real-time dental region is not finished, and the finished reminding message corresponding to any one of the real-time dental regions is used to indicate that the cleaning for the real-time dental region is finished; and
the step of determining the reminding message displayed on the base according to the real-time monitoring data comprises:
determining the unfinished reminding message corresponding to the real-time dental region when the cleaning duration data corresponding to any one of the real-time dental regions does not satisfy a first preset duration range; or
determining the finished reminding message corresponding to the real-time dental region when the cleaning duration data corresponding to any one of the real-time dental regions satisfies the first preset duration range.

18. The electronic device according to claim 12, wherein the real-time monitoring data comprises real-time pose data of the brush head, and the reminding message comprises region reminding message for indicating a position of the brush head in a mouth of the target user; and
the step of determining a reminding message displayed on the base according to the real-time monitoring data comprises:
determining real-time dental regions corresponding to the brush head according to the real-time pose data; and
determining the region reminding message according to the real-time dental regions.

19. The non-volatile computer readable storage medium according to claim 13, wherein the real-time monitoring data comprises real-time pose data of the brush head, and the reminding message comprises region reminding message for indicating a position of the brush head in a mouth of the target user; and
the step of determining a reminding message displayed on the base according to the real-time monitoring data comprises:
determining real-time dental regions corresponding to the brush head according to the real-time pose data; and
determining the region reminding message according to the real-time dental regions.
